(19) United States
(12) Patent Application Publication
(10) Pub. No.: US 2013/0093940 A1
(43) Pub. Date: Apr. 18, 2013

(54) Zoom Lens System, Interchangeable Lens Apparatus and Camera System

(71) Applicant: PANASONIC CORPORATION, Osaka (JP)

(72) Inventor: Yoshio Matsumura, Osaka (JP)

(73) Assignee: PANASONIC CORPORATION, Osaka (JP)

(21) Appl. No.: 13/650,148

(22) Filed: Oct. 12, 2012

(30) Foreign Application Priority Data
Oct. 17, 2011 (JP) 2011-227532
Sep. 7, 2012 (JP) 2012-197321

(51) Int. Cl. G02B 15/14; H04N 5/232; G02B 27/64

(52) U.S. Cl. 348/345; 359/557; 359/683; 348/E05.055

(57) ABSTRACT

A zoom lens system, in order from an object side to an image side, comprising: a first lens unit having positive optical power; a second lens unit having negative optical power; and a third lens unit having positive optical power, wherein the zoom lens system is provided with an image blur compensating lens unit which moves in a direction perpendicular to an optical axis in order to optically compensate image blur, which is a part of the third lens unit, and which is positioned closest to the object side in the third lens unit, and wherein the condition: 0.5<L_{T}/f_{T}<1.2 (L_{T} is an overall length of lens system at a telephoto limit, f_{T} is a focal length of the entire system at a telephoto limit) is satisfied.

### CROSS-REFERENCE TO RELATED APPLICATION

This application is based on application No. 2011-227532 filed in Japan on Oct. 17, 2011 and application No. 2012-197321 filed in Japan on Sep. 7, 2012, the contents of which are hereby incorporated by reference.

### BACKGROUND

1. Field

The present disclosure relates to zoom lens systems, interchangeable lens apparatuses, and camera systems.

2. Description of the Related Art

In recent years, interchangeable-lens type digital camera systems (also referred to simply as “camera systems”, hereinafter) have been spreading rapidly. Such interchangeable-lens type digital camera systems realize: taking of high-sensitive and high-quality images; high-speed focusing and high-speed image processing after image taking; and easy replacement of an interchangeable lens apparatus in accordance with a desired scene. Meanwhile, an interchangeable lens apparatus having a zoom lens system that forms an optical image with variable magnification is popular because it allows free change of focal length without the necessity of lens replacement.

Zoom lens systems having excellent optical performance from a wide-angle limit to a telephoto limit have been desired as zoom lens systems to be used in interchangeable lens apparatuses. Various kinds of zoom lens systems have been proposed, each having a positive lens unit located closest to an object side, and a multiple-unit construction.

Japanese Laid-Open Patent Publication No. 2002-107623 discloses a zoom lens having a four-unit construction, wherein a diaphragm is located between the second lens unit and the third lens unit, focusing is performed by the first lens unit and the forth lens unit, and image blur is optically compensated by the third lens unit.

Japanese Laid-Open Patent Publication No. 2004-212611 discloses a zoom lens having a five-unit construction of positive, negative, positive, negative, and positive, wherein, the intervals between adjacent lens units are all changed at the time of zooming, the third lens unit includes a cemented lens composed of a negative lens and a positive lens, and image blur is optically compensated by the cemented lens.

Japanese Laid-Open Patent Publication No. 2006-030340 discloses a zoom lens having a four-unit construction of positive, negative, positive, and positive, wherein the third lens unit includes a third-a negative lens unit and a third-b positive lens unit, and image blur is optically compensated by the third-a negative lens unit.

Japanese Laid-Open Patent Publication No. 2006-195068 discloses a zoom lens having a four-unit construction of positive, negative, positive, and positive, wherein the second lens unit and the fourth lens unit move at the timing of zooming, the first lens unit includes one or more negative lenses, a prism, and one or more positive lenses, and image blur is optically compensated by at least a part of the third lens unit.

Japanese Laid-Open Patent Publication No. 2006-267676 discloses a zoom lens having a four-unit construction of positive, negative, positive, and positive, wherein the second lens unit and the fourth lens unit move at the time of zooming, and the third lens unit includes a positive lens for image blur compensation, whose at least one surface is an aspheric surface, and a cemented lens.

### SUMMARY

The present disclosure provides a compact and lightweight zoom lens system having a short overall length as well as excellent optical performance. Further, the present disclosure provides an interchangeable lens apparatus and a camera system, each employing the zoom lens system.

(I) The novel concepts disclosed herein were achieved in order to solve the foregoing problems in the related art, and herein is disclosed:

a zoom lens system having a plurality of lens units, each lens unit being composed of at least one lens element, the zoom lens system, in order from an object side to an image side, comprising:

a first lens unit having positive optical power;

a second lens unit having negative optical power; and

a third lens unit having positive optical power, wherein

the zoom lens system is provided with an image blur compensating lens unit which moves in a direction perpendicular to an optical axis in order to optically compensate image blur, which is a part of the third lens unit, and which is positioned closest to the object side in the third lens unit, and wherein

the following condition (1) is satisfied:

0.5<L_{T}/f_{T}<1.2 (1)

where,

L_{T} is an overall length of lens system at a telephoto limit (a distance from an object side surface of a lens element arranged closest to the object side in the first lens unit, to an image surface at a telephoto limit), and

f_{T} is a focal length of the entire system at a telephoto limit.

The novel concepts disclosed herein were achieved in order to solve the foregoing problems in the related art, and herein is disclosed:

an interchangeable lens apparatus comprising:

a zoom lens system; and

a lens mount section which is connectable to a camera body including an image sensor for receiving an optical image formed by the zoom lens system and converting the optical image into an electric image signal, wherein

the zoom lens system has a plurality of lens units, each lens unit being composed of at least one lens element, the zoom lens system, in order from an object side to an image side, comprises:

a first lens unit having positive optical power;

a second lens unit having negative optical power; and

a third lens unit having positive optical power, wherein

the zoom lens system is provided with an image blur compensating lens unit which moves in a direction perpendicular to an optical axis in order to optically compensate image blur, which is a part of the third lens unit, and which is positioned closest to the object side in the third lens unit, and wherein

the following condition (1) is satisfied:

0.5<L_{T}/f_{T}<1.2 (1)

where,

L_{T} is an overall length of lens system at a telephoto limit (a distance from an object side surface of a lens element arranged closest to the object side in the first lens unit, to an image surface at a telephoto limit), and

f_{T} is a focal length of the entire system at a telephoto limit.

The novel concepts disclosed herein were achieved in order to solve the foregoing problems in the related art, and herein is disclosed:

a camera system comprising:

an interchangeable lens apparatus including a zoom lens system; and

a camera body which is detachably connected to the interchangeable lens apparatus via a camera mount section, and includes an image sensor for receiving an optical image formed by the zoom lens system and converting the optical image into an electric image signal, wherein

the zoom lens system has a plurality of lens units, each lens unit being composed of at least one lens element, the zoom lens system, in order from an object side to an image side, comprises:

a first lens unit having positive optical power;

a second lens unit having negative optical power; and

a third lens unit having positive optical power, wherein

the zoom lens system is provided with an image blur compensating lens unit which moves in a direction perpendicular to an optical axis in order to optically compensate image blur, which is a part of the third lens unit, and which is positioned closest to the object side in the third lens unit, and wherein

the following condition (1) is satisfied:

0.5<L_{T}/f_{T}<1.2 (1)

where,

L_{T} is an overall length of lens system at a telephoto limit (a distance from an object side surface of a lens element arranged closest to the object side in the first lens unit, to an image surface at a telephoto limit), and

f_{T} is a focal length of the entire system at a telephoto limit.

(II) The novel concepts disclosed herein were achieved in order to solve the foregoing problems in the related art, and herein is disclosed:

a zoom lens system having a plurality of lens units, each lens unit being composed of at least one lens element, the zoom lens system, in order from an object side to an image side, comprising:

a first lens unit having positive optical power;

a second lens unit having negative optical power;

a third lens unit having positive optical power;

a fourth lens unit having positive optical power; and

a fifth lens unit having negative optical power, wherein in zooming from a wide-angle limit to a telephoto limit at the time of image taking, the first lens unit and the fifth lens unit individually move relative to an image surface, wherein

in focusing from an infinity in-focus condition to a close-object in-focus condition, the fourth lens unit moves relative to the image surface, and wherein

the following condition (4) is satisfied:

0.03<T_{4G}/T_{3G}<0.9 (4)

where,

T_{3G} is an optical axial thickness of the third lens unit, and

T_{4G} is an optical axial thickness of the fourth lens unit.

The novel concepts disclosed herein were achieved in order to solve the foregoing problems in the related art, and herein is disclosed:

an interchangeable lens apparatus comprising:

a zoom lens system; and

a lens mount section which is connectable to a camera body including an image sensor for receiving an optical image formed by the zoom lens system and converting the optical image into an electric image signal, wherein

the zoom lens system has a plurality of lens units, each lens unit being composed of at least one lens element, the zoom lens system, in order from an object side to an image side, comprises:

a first lens unit having positive optical power;

a second lens unit having negative optical power;

a third lens unit having positive optical power;

a fourth lens unit having positive optical power; and

a fifth lens unit having negative optical power, wherein

in zooming from a wide-angle limit to a telephoto limit at the time of image taking, the first lens unit and the fifth lens unit individually move relative to an image surface, wherein

in focusing from an infinity in-focus condition to a close-object in-focus condition, the fourth lens unit moves relative to the image surface, and wherein

the following condition (4) is satisfied:

0.03<T_{4G}/T_{3G}<0.9 (4)

where,

T_{3G} is an optical axial thickness of the third lens unit, and

T_{4G} is an optical axial thickness of the fourth lens unit.

The novel concepts disclosed herein were achieved in order to solve the foregoing problems in the related art, and herein is disclosed:

a camera system comprising:

an interchangeable lens apparatus including a zoom lens system; and

a camera body which is detachably connected to the interchangeable lens apparatus via a camera mount section, and includes an image sensor for receiving an optical image formed by the zoom lens system and converting the optical image into an electric image signal, wherein

the zoom lens system has a plurality of lens units, each lens unit being composed of at least one lens element, the zoom lens system, in order from an object side to an image side, comprises:

a first lens unit having positive optical power;

a second lens unit having negative optical power;

a third lens unit having positive optical power;

a fourth lens unit having positive optical power; and

a fifth lens unit having negative optical power, wherein

in zooming from a wide-angle limit to a telephoto limit at the time of image taking, the first lens unit and the fifth lens unit individually move relative to an image surface, wherein

in focusing from an infinity in-focus condition to a close-object in-focus condition, the fourth lens unit moves relative to the image surface, and wherein

the following condition (4) is satisfied:

0.03<T_{4G}/T_{3G}<0.9 (4)

where,

T_{3G} is an optical axial thickness of the third lens unit, and

T_{4G} is an optical axial thickness of the fourth lens unit.

The zoom lens system according to the present disclosure is compact and lightweight, and has a short overall length as well as excellent optical performance.

### BRIEF DESCRIPTION OF THE DRAWINGS

This and other objects and features of the present disclosure will become clear from the following description, taken in conjunction with the exemplary embodiments with reference to the accompanied drawings in which:

FIG. 1 is a lens arrangement diagram showing an infinity in-focus condition of a zoom lens system according to Embodiment 1 (Numerical Example 1);

FIG. 2 is a longitudinal aberration diagram of an infinity in-focus condition of a zoom lens system according to Numerical Example 1;

FIG. 3 is a lateral aberration diagram of a zoom lens system according to Numerical Example 1 at a telephoto limit in a basic state where image blur compensation is not performed and in an image blur compensation state;

FIG. 4 is a lens arrangement diagram showing an infinity in-focus condition of a zoom lens system according to Embodiment 2 (Numerical Example 2);

FIG. 5 is a longitudinal aberration diagram of an infinity in-focus condition of a zoom lens system according to Numerical Example 2;

FIG. 6 is a lateral aberration diagram of a zoom lens system according to Numerical Example 2 at a telephoto limit in a basic state where image blur compensation is not performed and in an image blur compensation state;

FIG. 7 is a lens arrangement diagram showing an infinity in-focus condition of a zoom lens system according to Embodiment 3 (Numerical Example 3);

FIG. 8 is a longitudinal aberration diagram of an infinity in-focus condition of a zoom lens system according to Numerical Example 3;

FIG. 9 is a lateral aberration diagram of a zoom lens system according to Numerical Example 3 at a telephoto limit in a basic state where image blur compensation is not performed and in an image blur compensation state;

FIG. 10 is a lens arrangement diagram showing an infinity in-focus condition of a zoom lens system according to Embodiment 4 (Numerical Example 4);

FIG. 11 is a longitudinal aberration diagram of an infinity in-focus condition of a zoom lens system according to Numerical Example 4;

FIG. 12 is a lateral aberration diagram of a zoom lens system according to Numerical Example 4 at a telephoto limit in a basic state where image blur compensation is not performed and in an image blur compensation state;

FIG. 13 is a lens arrangement diagram showing an infinity in-focus condition of a zoom lens system according to Embodiment 5 (Numerical Example 5);

FIG. 14 is a longitudinal aberration diagram of an infinity in-focus condition of a zoom lens system according to Numerical Example 5;

FIG. 15 is a lateral aberration diagram of a zoom lens system according to Numerical Example 5 at a telephoto limit in a basic state where image blur compensation is not performed and in an image blur compensation state; and

FIG. 16 is a schematic construction diagram of an interchangeable-lens type digital camera system according to Embodiment 6.

### DETAILED DESCRIPTION

Hereinafter, embodiments will be described with reference to the drawings as appropriate. However, descriptions more detailed than necessary may be omitted. For example, detailed description of already well known matters or description of substantially identical configurations may be omitted. This is intended to avoid redundancy in the description below, and to facilitate understanding of those skilled in the art.

It should be noted that the applicants provide the attached drawings and the following description so that those skilled in the art can fully understand this disclosure. Therefore, the drawings and description are not intended to limit the subject defined by the claims.

### Embodiments 1 to 5

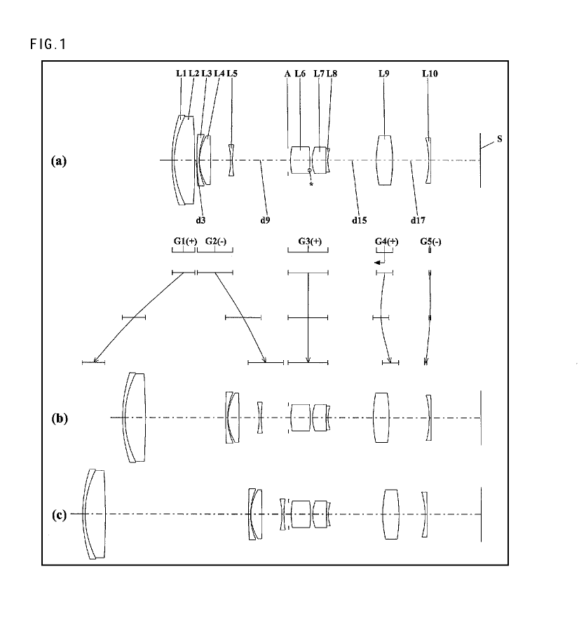

FIGS. 1, 4, 7, 10, and 13 are lens arrangement diagrams of zoom lens systems according to Embodiments 1 to 5, respectively.

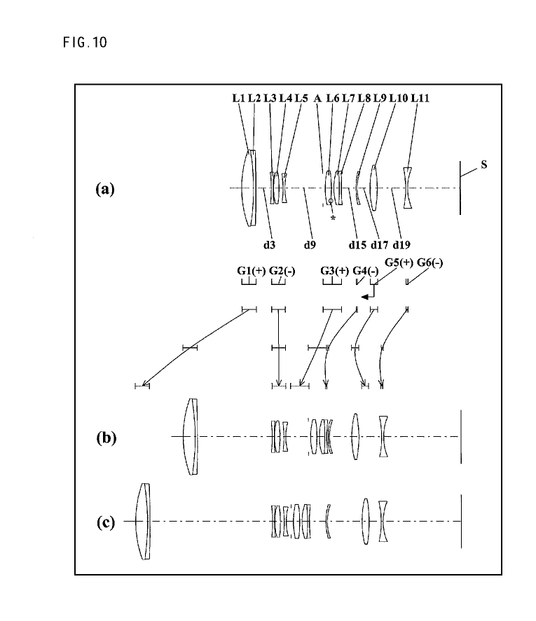

Each of FIGS. 1, 4, 7, 10, and 13 shows a zoom lens system in an infinity in-focus condition. In each Fig., part (a) shows a lens configuration at a wide-angle limit (in the minimum focal length condition: focal length f_{w}), part (b) shows a lens configuration at a middle position (in an intermediate focal length condition: focal length f_{M}=√(f_{w}*f_{T})), and part (c) shows a lens configuration at a telephoto limit (in the maximum focal length condition: focal length f_{T}). Further, in each Fig., an arrow of straight or curved line provided between part (a) and part (b) indicates the movement of each lens unit from a wide-angle limit through a middle position to a telephoto limit. Moreover, in each Fig., an arrow imparted to a lens unit indicates focusing from an infinity in-focus condition to a close-object in-focus condition. That is, in FIGS. 1, 4, 7, and 13, the arrow indicates a direction in which a fourth lens unit G4 described later moves in focusing from an infinity in-focus condition to a close-object in-focus condition. In FIG. 10, the arrow indicates a direction in which a fifth lens unit G5 described later moves in focusing from an infinity in-focus condition to a close-object in-focus condition.

Each of the zoom lens systems according to Embodiments 1 to 3 and 5, in order from the object side to the image side, comprises a first lens unit G1 having positive optical power, a second lens unit G2 having negative optical power, a third lens unit G3 having positive optical power, a fourth lens unit G4 having positive optical power, and a fifth lens unit G5 having negative optical power. The zoom lens system according to Embodiment 4, in order from the object side to the image side, comprises a first lens unit G1 having positive optical power, a second lens unit G2 having negative optical power, a third lens unit G3 having positive optical power, a fourth lens unit G4 having negative optical power, a fifth lens unit G5 having positive optical power, and a sixth lens unit G6 having negative optical power.

In FIGS. 1, 4, 7, 10, and 13, an asterisk “*” imparted to a particular surface indicates that the surface is aspheric. In each Fig., symbol (+) or (−) imparted to the symbol of each lens unit corresponds to the sign of the optical power of the lens unit. In each Fig., a straight line located on the most right-hand side indicates the position of an image surface S. As shown in each Fig., an aperture diaphragm A is provided between the second lens unit G2 and the third lens unit G3.

### Embodiment 1

As shown in FIG. 1, the first lens unit G1, in order from the object side to the image side, comprises: a negative meniscus first lens element L1 with the convex surface facing the object side; and a bi-convex second lens element L2. The first lens element L1 and the second lens element L2 are cemented with each other.

The second lens unit G2, in order from the object side to the image side, comprises: a negative meniscus third lens element L3 with the convex surface facing the object side; a bi-convex fourth lens element L4; and a bi-concave fifth lens element L5.

The third lens unit G3, in order from the object side to the image side, comprises: a bi-convex sixth lens element L6; a positive meniscus seventh lens element L7 with the convex surface facing the object side; and a negative meniscus eighth lens element L8 with the convex surface facing the object side. Among these, the seventh lens element L7 and the eighth lens element L8 are cemented with each other. The sixth lens element L6 has an aspheric image side surface.

The fourth lens unit G4 comprises solely a bi-convex ninth lens element L9.

The fifth lens unit G5 comprises solely a negative meniscus tenth lens element L10 with the convex surface facing the image side.

In zooming from a wide-angle limit to a telephoto limit at the time of image taking, the first lens unit G1 moves to the object side, the second lens unit G2 moves to the image side, the third lens unit G3 does not move, the fourth lens unit G4 moves to the image side, and the fifth lens unit G5 moves to the object side. That is, in zooming, the first lens unit G1, the second lens unit G2, the fourth lens unit G4, and the fifth lens unit G5 individually move along the optical axis such that the interval between the first lens unit G1 and the second lens unit G2 increases, that the interval between the second lens unit G2 and the third lens unit G3 decreases, that the interval between the third lens unit G3 and the fourth lens unit G4 increases, and that the interval between the fourth lens unit G4 and the fifth lens unit G5 decreases. Like the third lens unit G3, the aperture diaphragm A does not move.

In focusing from an infinity in-focus condition to a close-object in-focus condition, the fourth lens unit G4 moves to the object side along the optical axis.

Further, the sixth lens element L6 corresponds to an image blur compensating lens unit described later. Then, by moving the sixth lens element L6 in a direction perpendicular to the optical axis, image point movement caused by vibration of the entire system can be compensated, that is, image blur caused by hand blur, vibration, and the like can be compensated optically.

### Embodiment 2

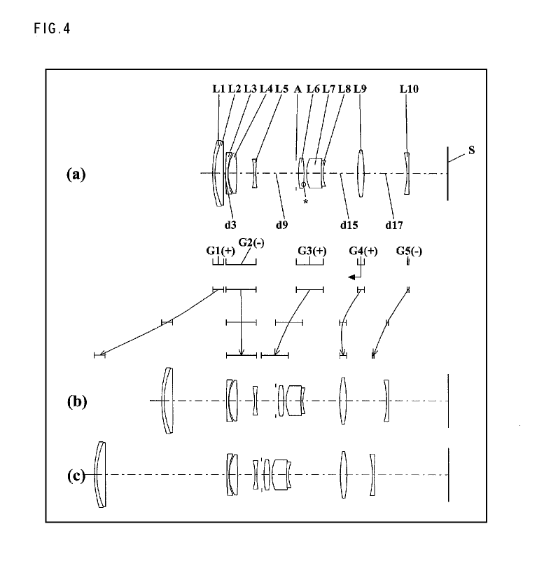

As shown in FIG. 4, the first lens unit G1, in order from the object side to the image side, comprises: a negative meniscus first lens element 1 with the convex surface facing the object side; and a bi-convex second lens element L2. The first lens element L1 and the second lens element L2 are cemented with each other.

The second lens unit G2, in order from the object side to the image side, comprises: a negative meniscus third lens element L3 with the convex surface facing the object side; a bi-convex fourth lens element L4; and a bi-concave fifth lens element L5.

The third lens unit G3, in order from the object side to the image side, comprises: a bi-convex sixth lens element L6; a positive meniscus seventh lens element L7 with the convex surface facing the object side; and a negative meniscus eighth lens element L8 with the convex surface facing the object side. Among these, the seventh lens element L7 and the eighth lens element L8 are cemented with each other. The sixth lens element L6 has an aspheric image side surface.

The fourth lens unit G4 comprises solely a bi-convex ninth lens element L9.

The fifth lens unit G5 comprises solely a bi-concave tenth lens element L10.

In zooming from a wide-angle limit to a telephoto limit at the time of image taking, the first lens unit G1 moves to the object side, the second lens unit G2 does not move, the third lens unit G3 moves to the object side, the fourth lens unit G4 moves to the object side, and the fifth lens unit G5 moves to the object side. That is, in zooming, the first lens unit G1, the third lens unit G3, the fourth lens unit G4, and the fifth lens unit G5 individually move along the optical axis such that the interval between the first lens unit G1 and the second lens unit G2 increases, and that the interval between the second lens unit G2 and the third lens unit G3 decreases. The aperture diaphragm A moves integrally with the third lens unit G3 to the object side along the optical axis.

In focusing from an infinity in-focus condition to a close-object in-focus condition, the fourth lens unit G4 moves to the object side along the optical axis.

Further, the sixth lens element L6 corresponds to an image blur compensating lens unit described later. Then, by moving the sixth lens element L6 in a direction perpendicular to the optical axis, image point movement caused by vibration of the entire system can be compensated, that is, image blur caused by hand blur, vibration, and the like can be compensated optically.

### Embodiment 3

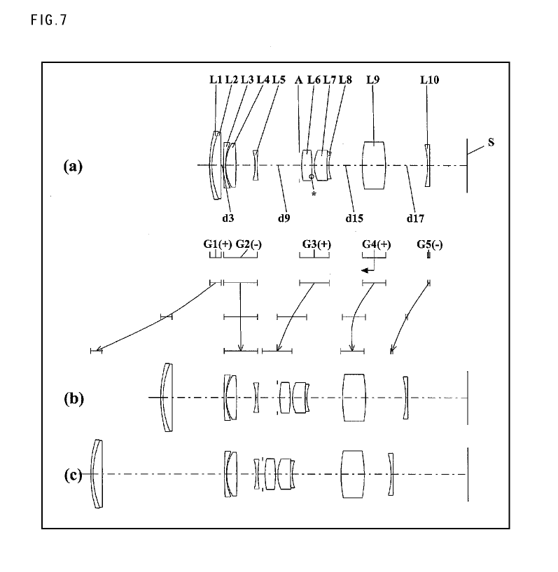

As shown in FIG. 7, the first lens unit G1, in order from the object side to the image side, comprises: a negative meniscus first lens element L1 with the convex surface facing the object side; and a bi-convex second lens element L2. The first lens element L1 and the second lens element L2 are cemented with each other.

The second lens unit G2, in order from the object side to the image side, comprises: a negative meniscus third lens element L3 with the convex surface facing the object side; a bi-convex fourth lens element L4; and a bi-concave fifth lens element L5.

The third lens unit G3, in order from the object side to the image side, comprises: a bi-convex sixth lens element L6; a positive meniscus seventh lens element L7 with the convex surface facing the object side; and a negative meniscus eighth lens element L8 with the convex surface facing the object side. Among these, the seventh lens element L7 and the eighth lens element L8 are cemented with each other. The sixth lens element L6 has an aspheric image side surface.

The fourth lens unit G4 comprises solely a bi-convex ninth lens element L9.

The fifth lens unit G5 comprises solely a bi-concave tenth lens element L10.

In zooming from a wide-angle limit to a telephoto limit at the time of image taking, the first lens unit G1 moves to the object side, the second lens unit G2 does not move, the third lens unit G3 moves to the object side, the fourth lens unit G4 moves to the object side, and the fifth lens unit G5 moves to the object side. That is, in zooming, the first lens unit G1, the third lens unit G3, the fourth lens unit G4, and the fifth lens unit G5 individually move along the optical axis such that the interval between the first lens unit G1 and the second lens unit G2 increases, and that the interval between the second lens unit G2 and the third lens unit G3 decreases. The aperture diaphragm A moves integrally with the third lens unit G3 to the object side along the optical axis.

In focusing from an infinity in-focus condition to a close-object in-focus condition, the fourth lens unit G4 moves to the object side along the optical axis.

Further, the sixth lens element L6 corresponds to an image blur compensating lens unit described later. Then, by moving the sixth lens element L6 in a direction perpendicular to the optical axis, image point movement caused by vibration of the entire system can be compensated, that is, image blur caused by hand blur, vibration, and the like can be compensated optically.

### Embodiment 4

As shown in FIG. 10, the first lens unit G1, in order from the object side to the image side, comprises: a bi-convex first lens element L1; and a negative meniscus second lens element L2 with the convex surface facing the image side. The first lens element L1 and the second lens element L2 are cemented with each other.

The second lens unit G2, in order from the object side to the image side, comprises: a bi-concave third lens element L3; a bi-convex fourth lens element L4; and a bi-concave fifth lens element L5.

The third lens unit G3, in order from the object side to the image side, comprises: a bi-convex sixth lens element L6; a bi-convex seventh lens element L7; and a bi-concave eighth lens element L8. Among these, the seventh lens element L7 and the eighth lens element L8 are cemented with each other. The sixth lens element L6 has an aspheric image side surface.

The fourth lens unit G4 comprises solely a negative meniscus ninth lens element L9 with the convex surface facing the object side.

The fifth lens unit G5 comprises solely a bi-convex tenth lens element L10.

The sixth lens unit G6 comprises solely a bi-concave eleventh lens element L11.

In zooming from a wide-angle limit to a telephoto limit at the time of image taking, the first lens unit G1 moves to the object side, the second lens unit G2 does not move, the third lens unit G3 moves to the object side, the fourth lens unit G4 moves to the object side, the fifth lens unit G5 moves to the object side, and the sixth lens unit G6 moves to the object side. That is, in zooming, the first lens unit G1, the third lens unit G3, the fourth lens unit G4, the fifth lens unit G5, and the sixth lens unit G6 individually move along the optical axis such that the interval between the first lens unit G1 and the second lens unit G2 increases, and that the interval between the second lens unit G2 and the third lens unit G3 decreases. The aperture diaphragm A moves integrally with the third lens unit G3 to the object side along the optical axis.

In focusing from an infinity in-focus condition to a close-object in-focus condition, the fifth lens unit G5 moves to the object side along the optical axis.

Further, the sixth lens element L6 corresponds to an image blur compensating lens unit described later. Then, by moving the sixth lens element L6 in a direction perpendicular to the optical axis, image point movement caused by vibration of the entire system can be compensated, that is, image blur caused by hand blur, vibration, and the like can be compensated optically.

### Embodiment 5

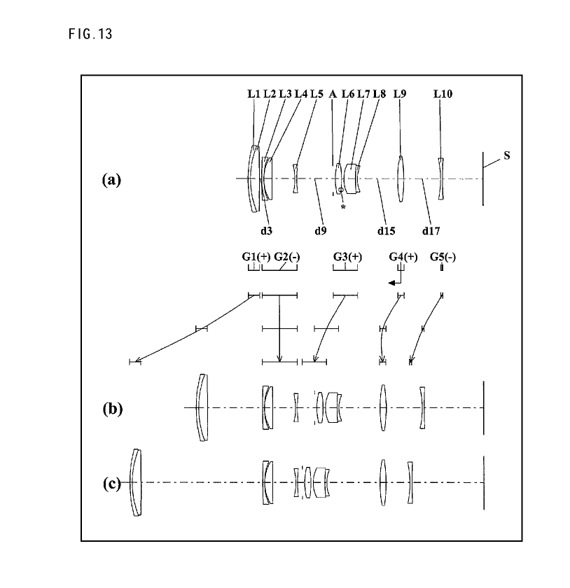

As shown in FIG. 13, the first lens unit G1, in order from the object side to the image side, comprises: a negative meniscus first lens element L1 with the convex surface facing the object side; and a bi-convex second lens element L2. The first lens element L1 and the second lens element L2 are cemented with each other.

The second lens unit G2, in order from the object side to the image side, comprises: a negative meniscus third lens element L3 with the convex surface facing the object side; a positive meniscus fourth lens element L4 with the convex surface facing the object side; and a bi-concave fifth lens element L5.

The third lens unit G3, in order from the object side to the image side, comprises: a bi-convex sixth lens element L6; a positive meniscus seventh lens element L7 with the convex surface facing the object side; and a negative meniscus eighth lens element L8 with the convex surface facing the object side. Among these, the seventh lens element L7 and the eighth lens element L8 are cemented with each other. The sixth lens element L6 has an aspheric image side surface.

The fourth lens unit G4 comprises solely a bi-convex ninth lens element L9.

The fifth lens unit G5 comprises solely a bi-concave tenth lens element L10.

In zooming from a wide-angle limit to a telephoto limit at the time of image taking, the first lens unit G1 moves to the object side, the second lens unit G2 does not move, the third lens unit G3 moves to the object side, the fourth lens unit G4 moves to the object side, and the fifth lens unit G5 moves to the object side. That is, in zooming, the first lens unit G1, the third lens unit G3, the fourth lens unit G4, and the fifth lens unit G5 individually move along the optical axis such that the interval between the first lens unit G1 and the second lens unit G2 increases, and that the interval between the second lens unit G2 and the third lens unit G3 decreases. The aperture diaphragm A moves integrally with the third lens unit G3 to the object side along the optical axis.

In focusing from an infinity in-focus condition to a close-object in-focus condition, the fourth lens unit G4 moves to the object side along the optical axis.

Further, the sixth lens element L6 corresponds to an image blur compensating lens unit described later. Then, by moving the sixth lens element L6 in a direction perpendicular to the optical axis, image point movement caused by vibration of the entire system can be compensated, that is, image blur caused by hand blur, vibration, and the like can be compensated optically.

As described above, Embodiments 1 to 5 have been described as examples of art disclosed in the present application. However, the art in the present disclosure is not limited to these embodiments. It is understood that various modifications, replacements, additions, omissions, and the like have been performed in these embodiments to give optional embodiments, and the art in the present disclosure can be applied to the optional embodiments.

The following description is given for conditions that a zoom lens system like the zoom lens systems according to Embodiments 1 to 5 can satisfy. Here, a plurality of beneficial conditions is set forth for the zoom lens system according to each embodiment. A construction that satisfies all the plural conditions is most effective for the zoom lens system. However, when an individual condition is satisfied, a zoom lens system having the corresponding effect is obtained.

For example, in a zoom lens system like the zoom lens systems according to Embodiments 1 to 5, having a plurality of lens units, each lens unit being composed of at least one lens element, the zoom lens system, in order from an object side to an image side, comprising: a first lens unit having positive optical power; a second lens unit having negative optical power; and a third lens unit having positive optical power, wherein the zoom lens system is provided with an image blur compensating lens unit which moves in a direction perpendicular to the optical axis in order to optically compensate image blur, which is a part of the third lens unit, and which is positioned closest to the object side in the third lens unit (this lens configuration is referred to as a basic configuration I of the embodiment, hereinafter), the following condition (1) is satisfied. Further, in a zoom lens system like the zoom lens systems according to Embodiments 1 to 3 and 5, having a plurality of lens units, each lens unit being composed of at least one lens element, the zoom lens system, in order from an object side to an image side, comprising: a first lens unit having positive optical power; a second lens unit having negative optical power; a third lens unit having positive optical power, a fourth lens unit having positive optical power, and a fifth lens unit having negative optical power, wherein in zooming from a wide-angle limit to a telephoto limit at the time of image taking, the first lens unit and the fifth lens unit move relative to an image surface, and in focusing from an infinity in-focus condition to a close-object in-focus condition, the fourth lens unit moves relative to the image surface (this lens configuration is referred to as a basic configuration II of the embodiment, hereinafter), the following condition (1) is beneficially satisfied.

0.5<L_{T}/f_{T}<1.2 (1)

where,

L_{T} is an overall length of lens system at a telephoto limit (a distance from an object side surface of a lens element arranged closest to the object side in the first lens unit, to the image surface at a telephoto limit), and

f_{T} is a focal length of the entire system at a telephoto limit.

The condition (1) sets forth a relationship between the overall length of lens system at a telephoto limit and the focal length of the entire system at a telephoto limit. When the value goes below the lower limit of the condition (1), the focal lengths of the respective lens units become excessively short, and therefore compensation of curvature of field at a telephoto limit becomes difficult. In contrast, when the value exceeds the upper limit of the condition (1), the overall length of lens system at a telephoto limit becomes excessively long, and therefore it becomes difficult to provide compact lens barrel, interchangeable lens apparatus, and camera system.

When at least one of the following conditions (1)′ and (1)″ is satisfied, the above-mentioned effect is achieved more successfully.

0.8<L_{T}/f_{T} (1)′

L_{T}/f_{T}<1.15 (1)″

A zoom lens system having the basic configuration II like the zoom lens systems according to Embodiments 1 to 3 and 5 satisfies the following condition (4). Further, it is beneficial that a zoom lens system having the basic configuration I and further including the fourth lens unit on the image side relative to the third lens unit, like the zoom lens systems according to Embodiments 1 to 5, satisfies the following condition (4).

0.03<T_{4G}/T_{3G}<0.9 (4)

where,

T_{3G} is an optical axial thickness of the third lens unit, and

T_{4G} is an optical axial thickness of the fourth lens unit.

The condition (4) sets forth a relationship between the optical axial thickness of the third lens unit and the optical axial thickness of the fourth lens unit. When the value goes below the lower limit of the condition (4), the optical axial thickness of the fourth lens unit becomes excessively small, and therefore compensation of fluctuation in curvature of field in association with focusing becomes difficult. In contrast, when the value exceeds the upper limit of the condition (4), the optical axial thickness of the third lens unit becomes excessively small, and therefore compensation of fluctuation in spherical aberration in association with zooming becomes difficult.

When at least one of the following conditions (4)′ and (4)″ is satisfied, the above-mentioned effect is achieved more successfully.

0.05<T_{4G}/T_{3G} (4)′

T_{4G}/T_{3G}<0.5 (4)″

It is beneficial that a zoom lens system having the basic configuration I like the zoom lens systems according to Embodiments 1 to 5 satisfies the following condition (2). Further, it is beneficial that a zoom lens system having the basic configuration II and including an image blur compensating lens unit which moves in a direction perpendicular to the optical axis in order to optically compensate image blur, which is a part of the third lens unit, and which is positioned closest to the object side in the third lens unit, like the zoom lens systems according to Embodiments 1 to 3 and 5, satisfies the following condition (2).

0.3<T_{3subG}/T_{1G}<1.5 (2)

where,

T_{3subG} is an optical axial thickness of the image blur compensating lens unit, and

T_{1G} is an optical axial thickness of the first lens unit.

The condition (2) set forth a relationship between the optical axial thickness of the image blur compensating lens unit which is a part of the third lens unit and is positioned closest to the object side in the third lens unit, and the optical axial thickness of the first lens unit. When the value goes below the lower limit of the condition (2), the optical axial thickness of the first lens unit becomes excessively large, and therefore compensation of astigmatism particularly at a telephoto limit becomes difficult. In contrast, when the value exceeds the upper limit of the condition (2), the optical axial thickness of the image blur compensating lens unit becomes excessively large, and therefore the configuration of the drive mechanism for the image blur compensating lens unit becomes enlarged, which makes it difficult to provide compact lens barrel, interchangeable lens apparatus, and camera system. Further, compensation of decentering astigmatism at the time of image blur compensation becomes difficult.

When at least one of the following conditions (2)′ and (2)″ is satisfied, the above-mentioned effect is achieved more successfully.

0.45<T_{3subG}/T_{1G} (2)′

T_{3subG}/T_{1G}<0.9 (2)″

It is beneficial that a zoom lens system having the basic configuration I like the zoom lens systems according to Embodiments 1 to 5 satisfies the following condition (3). Further, it is beneficial that a zoom lens system having the basic configuration II like the zoom lens systems according to Embodiments 1 to 3 and 5 satisfies the following condition (3).

0.05<T_{1G}/f_{w}<0.3 (3)

where,

T_{1G} is an optical axial thickness of the first lens unit, and

f_{w} is a focal length of the entire system at a wide-angle limit.

The condition (3) sets forth a relationship between the optical axial thickness of the first lens unit and the focal length of the entire system at a wide-angle limit. When the value goes below the lower limit of the condition (3), the optical axial thickness of the first lens unit becomes excessively small relative to the focal length of the entire system at a wide-angle limit, and therefore compensation of astigmatism particularly at a wide-angle limit becomes difficult. In contrast, when the value exceeds the upper limit of the condition (3), the optical axial thickness of the first lens unit becomes excessively large, and therefore compensation of astigmatism particularly at a telephoto limit becomes difficult. Further, it becomes difficult to provide compact lens barrel, interchangeable lens apparatus, and camera system.

When at least one of the following conditions (3)′ and (3)″ is satisfied, the above-mentioned effect is achieved more successfully.

0.08<T_{1G}/f_{w} (3)′

T_{1G}/f_{w}<0.21 (3)″

It is beneficial that a zoom lens system having the basic configuration I like the zoom lens systems according to Embodiments 1 to 5 satisfies the following condition (5). Further, it is beneficial that a zoom lens system having the basic configuration II like the zoom lens systems according to Embodiments 1 to 3 and 5 satisfies the following condition (5).

−2.0<f_{3G}/f_{2G}<−1.0 (5)

where,

f_{2G} is a focal length of the second lens unit, and

f_{3G} is a focal length of the third lens unit.

The condition (5) sets forth a relationship between the focal length of the second lens unit and the focal length of the third lens unit. When the value goes below the lower limit of the condition (5), the focal length of the second lens unit become excessively short, and therefore compensation of curvature of field particularly at a wide-angle limit becomes difficult. In contrast, when the value exceeds the upper limit of the condition (5), the focal length of the third lens unit becomes excessively short, and therefore compensation of fluctuation in spherical aberration in association with zooming becomes difficult.

When at least one of the following conditions (5)′ and (5)″ is satisfied, the above-mentioned effect is achieved more successfully.

−1.8<f_{3G}/f_{2G} (5)′

f_{3G}/f_{2G}<−1.2 (5)″

Each of the zoom lens systems according to Embodiments 1 to 5 is provided with the image blur compensating lens unit which moves in a direction perpendicular to the optical axis in order to optically compensate image blur, which is a part of the third lens unit, and which is positioned closest to the object side in the third lens unit. By virtue of this image blur compensating lens unit, image point movement caused by vibration of the entire system can be compensated.

When compensating image point movement caused by vibration of the entire system, the image blur compensating lens unit moves in the direction perpendicular to the optical axis, so that image blur is compensated in a state that size increase in the entire zoom lens system is suppressed to realize a compact construction and that excellent imaging characteristics such as small decentering coma aberration and small decentering astigmatism are satisfied.

The image blur compensating lens unit may be a single lens element or a cemented lens element composed of a plurality of adjacent lens elements, which is positioned closest to the object side in the third lens unit. It is beneficial that the image blur compensating lens unit is a single lens element. When the image blur compensating lens unit is composed of a plurality of lens elements, the configuration of the drive mechanism for the image blur compensating lens unit becomes enlarged, and therefore it becomes difficult to provide compact lens barrel, interchangeable lens apparatus, and camera system.

It is beneficial that the first lens unit is composed of two or less lens elements, like in the zoom lens systems according to Embodiments 1 to 5. When the first lens unit is composed of three or more lens elements, the diameter of the first lens unit is increased, and therefore compensation of astigmatism at a wide-angle limit becomes difficult.

It is beneficial that at least one lens unit is fixed relative to the image surface in zooming from a wide-angle limit to a telephoto limit at the time of image taking, like in the zoom lens systems according to Embodiments 1 to 5. When all the lens units move relative to the image surface in zooming, the configuration of the drive mechanism for the moving lens units becomes enlarged, and therefore it becomes difficult to provide compact lens barrel, interchangeable lens apparatus, and camera system.

It is beneficial that the fourth lens unit is composed of one lens element, like in the zoom lens systems according to Embodiments 1 to 3 and 5 (zoom lens systems having the basic configuration II). When the fourth lens unit is composed of a plurality of lens elements, the thickness of the fourth lens unit becomes large, and therefore compensation of coma aberration at a wide-angle limit becomes difficult.

Each of the lens units constituting the zoom lens system according to any of Embodiments 1 to 5 is composed exclusively of refractive type lens elements that deflect the incident light by refraction (that is, lens elements of a type in which deflection is achieved at the interface between media each having a distinct refractive index). However, the present invention is not limited to this. For example, the lens units may employ diffractive type lens elements that deflect the incident light by diffraction; refractive-diffractive hybrid type lens elements that deflect the incident light by a combination of diffraction and refraction; or gradient index type lens elements that deflect the incident light by distribution of refractive index in the medium. In particular, in refractive-diffractive hybrid type lens elements, when a diffraction structure is formed in the interface between media having mutually different refractive indices, wavelength dependence in the diffraction efficiency is improved. Thus, such a configuration is beneficial.

### Embodiment 6

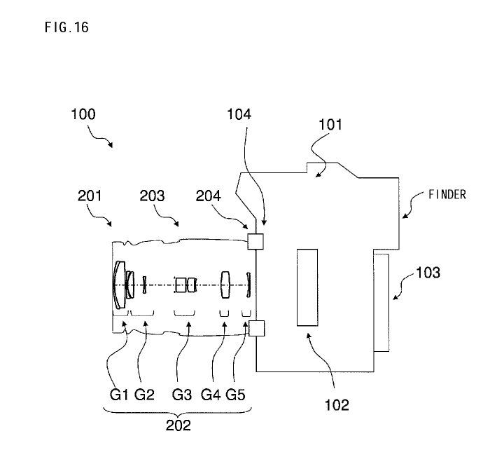

FIG. 16 is a schematic construction diagram of an interchangeable-lens type digital camera system according to Embodiment 6.

The interchangeable-lens type digital camera system 100 according to Embodiment 6 includes a camera body 101, and an interchangeable lens apparatus 201 which is detachably connected to the camera body 101.

The camera body 101 includes: an image sensor 102 which receives an optical image formed by a zoom lens system 202 of the interchangeable lens apparatus 201, and converts the optical image into an electric image signal; a liquid crystal monitor 103 which displays the image signal obtained by the image sensor 102; and a camera mount section 104. On the other hand, the interchangeable lens apparatus 201 includes: a zoom lens system 202 according to any of Embodiments 1 to 5; a lens barrel 203 which holds the zoom lens system 202; and a lens mount section 204 connected to the camera mount section 104 of the camera body 101. The camera mount section 104 and the lens mount section 204 are physically connected to each other. Moreover, the camera mount section 104 and the lens mount section 204 function as interfaces which allow the camera body 101 and the interchangeable lens apparatus 201 to exchange signals, by electrically connecting a controller (not shown) in the camera body 101 and a controller (not shown) in the interchangeable lens apparatus 201. In FIG. 16, the zoom lens system according to Embodiment 1 is employed as the zoom lens system 202.

In Embodiment 6, since the zoom lens system 202 according to any of Embodiments 1 to 5 is employed, a compact interchangeable lens apparatus having excellent imaging performance can be realized at low cost. Moreover, size reduction and cost reduction of the entire camera system 100 according to Embodiment 6 can be achieved. In the zoom lens systems according to Embodiments 1 to 5, the entire zooming range need not be used. That is, in accordance with a desired zooming range, a range where satisfactory optical performance is obtained may exclusively be used. Then, the zoom lens system may be used as one having a lower magnification than the zoom lens systems described in Embodiments 1 to 5.

As described above, Embodiment 6 has been described as an example of art disclosed in the present application. However, the art in the present disclosure is not limited to this embodiment. It is understood that various modifications, replacements, additions, omissions, and the like have been performed in this embodiment to give optional embodiments, and the art in the present disclosure can be applied to the optional embodiments.

The following description is given for numerical examples in which the zoom lens system according to Embodiments 1 to 5 are implemented practically. In the numerical examples, the units of the length in the tables are all “mm”, while the units of the view angle are all “∘”. Moreover, in the numerical examples, r is the radius of curvature, d is the axial distance, nd is the refractive index to the d-line, and vd is the Abbe number to the d-line. In the numerical examples, the surfaces marked with * are aspheric surfaces, and the aspheric surface configuration is defined by the following expression.

$$Z = \frac{{h}^{2} / r}{1 + \sqrt{1 - ( 1 + κ ) {( h / r )}^{2}}} + \sum {A}_{n} {h}^{n}$$

Here, the symbols in the formula indicate the following quantities.

Z is a distance from a point on an aspherical surface at a height h relative to the optical axis to a tangential plane at the vertex of the aspherical surface,

h is a height relative to the optical axis,

r is a radius of curvature at the top,

κ is a conic constant, and

Aₙ is a n-th order aspherical coefficient.

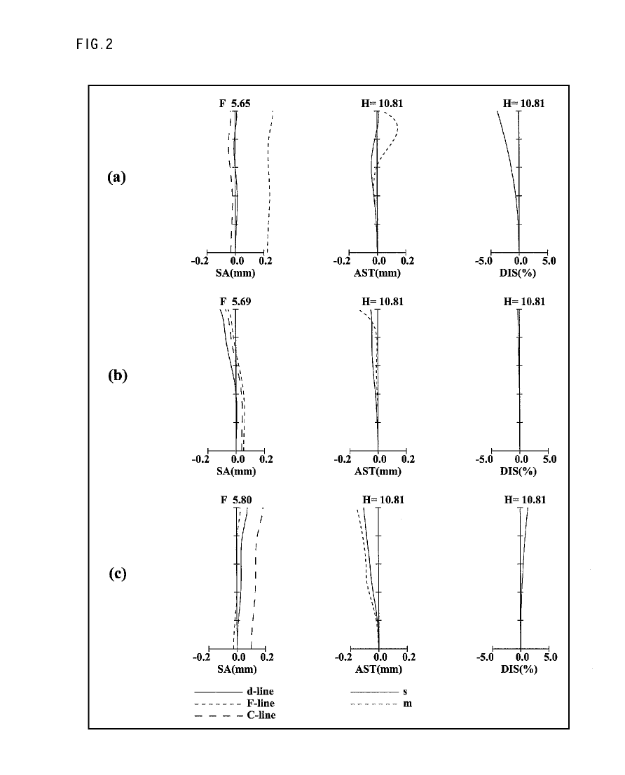

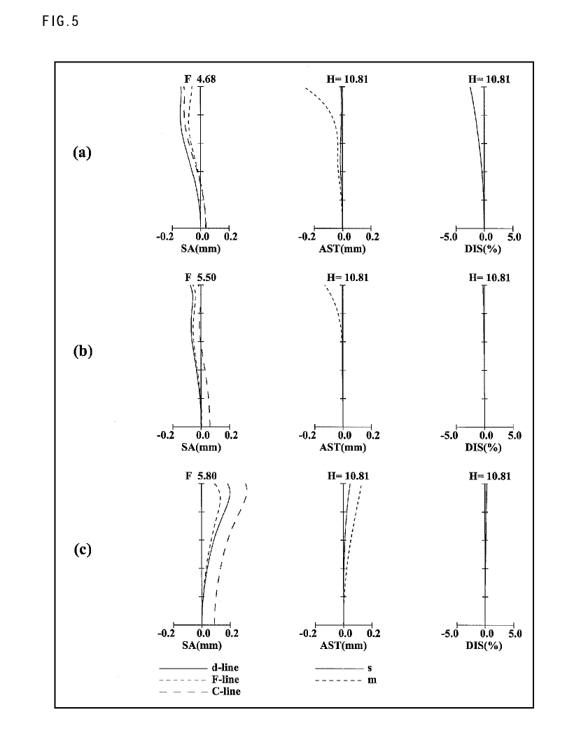

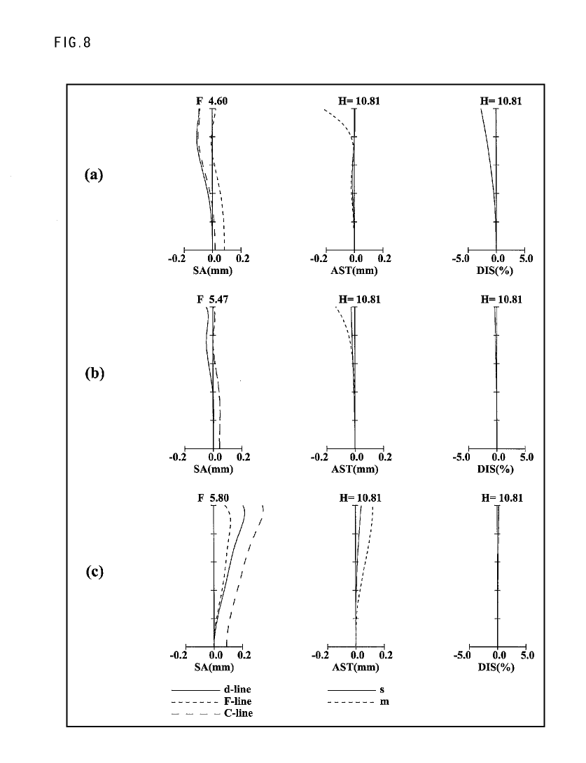

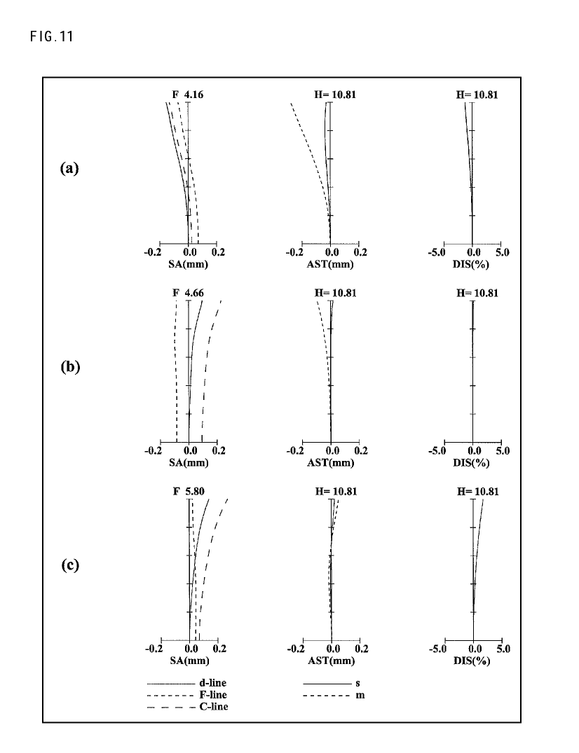

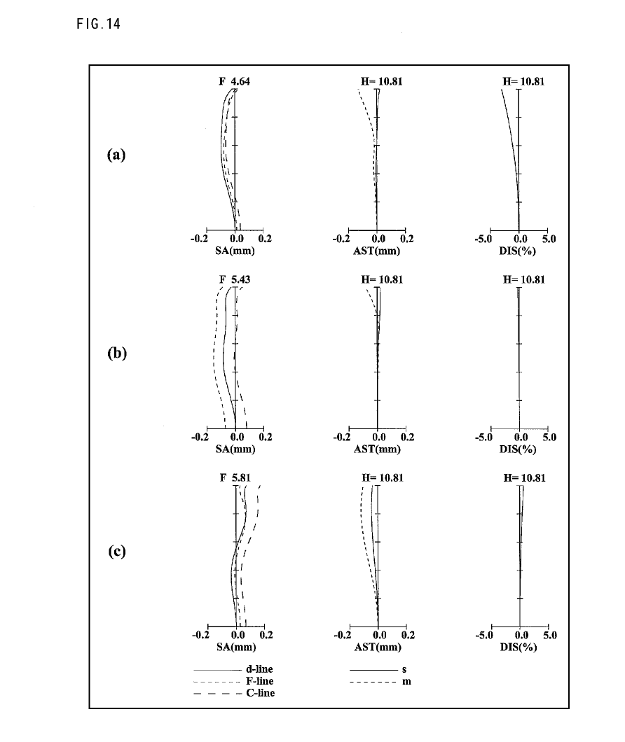

FIGS. 2, 5, 8, 11 and 14 are longitudinal aberration diagrams of an infinity in-focus condition of the zoom lens systems according to Numerical Examples 1 to 5, respectively.

In each longitudinal aberration diagram, part (a) shows the aberration at a wide-angle limit, part (b) shows the aberration at a middle position, and part (c) shows the aberration at a telephoto limit. Each longitudinal aberration diagram, in order from the left-hand side, shows the spherical aberration (SA (mm)), the astigmatism (AST (mm)) and the distortion (DIS (%)). In each spherical aberration diagram, the vertical axis indicates the F-number (in each Fig., indicated as F), and the solid line, the short dash line and the long dash line indicate the characteristics to the d-line, the F-line and the C-line, respectively. In each astigmatism diagram, the vertical axis indicates the image height (in each Fig., indicated as H), and the solid line and the dash line indicate the characteristics to the sagittal plane (in each Fig., indicated as “s”) and the meridional plane (in each Fig., indicated as “m”), respectively. In each distortion diagram, the vertical axis indicates the image height (in each Fig., indicated as H).

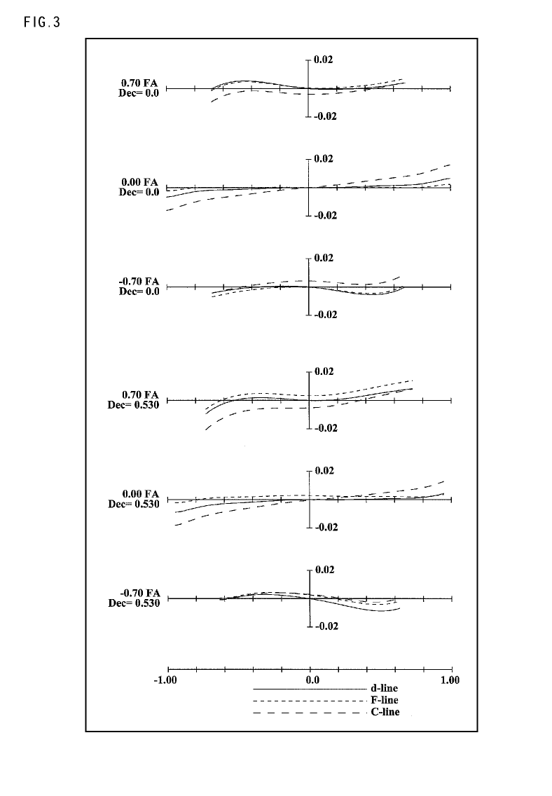

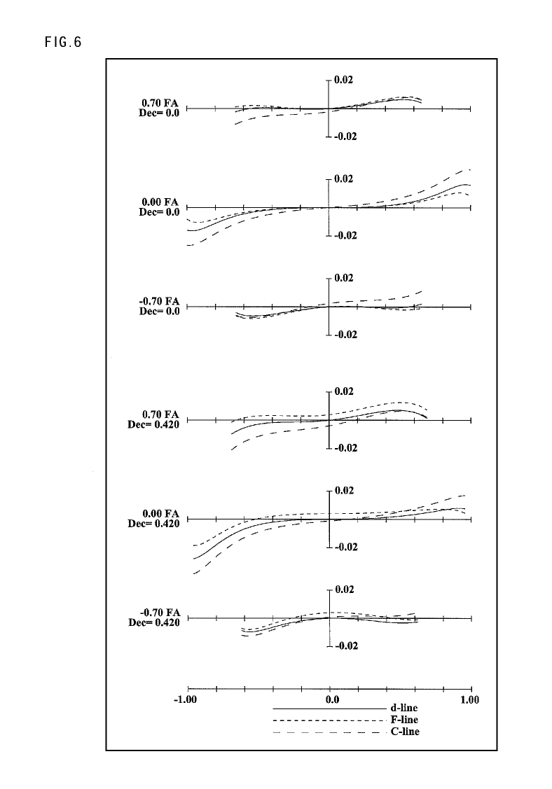

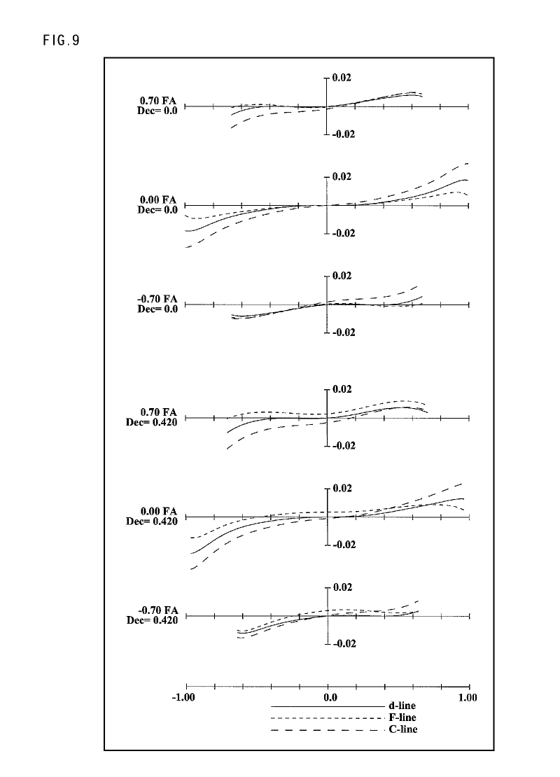

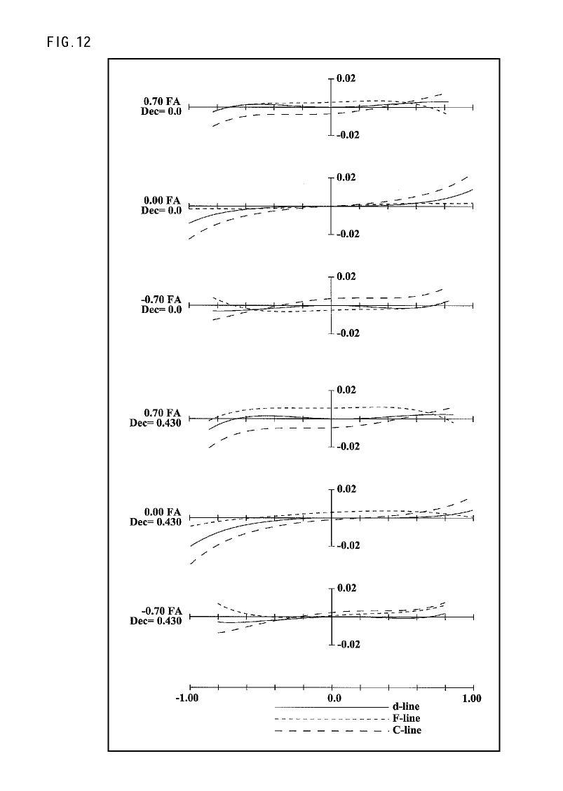

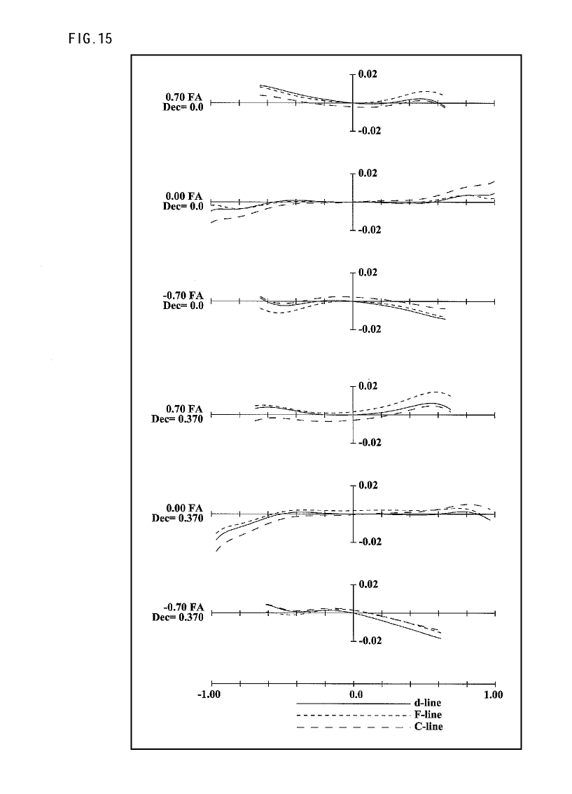

FIGS. 3, 6, 9, 12 and 15 are lateral aberration diagrams of the zoom lens systems at a telephoto limit according to Numerical Examples 1 to 5, respectively.

In each lateral aberration diagram, the aberration diagrams in the upper three parts correspond to a basic state where image blur compensation is not performed at a telephoto limit, while the aberration diagrams in the lower three parts correspond to an image blur compensation state where the image blur compensating lens unit is moved by a predetermined amount in a direction perpendicular to the optical axis at a telephoto limit. Among the lateral aberration diagrams of a basic state, the upper part shows the lateral aberration at an image point of 70% of the maximum image height, the middle part shows the lateral aberration at the axial image point, and the lower part shows the lateral aberration at an image point of −70% of the maximum image height. Among the lateral aberration diagrams of an image blur compensation state, the upper part shows the lateral aberration at an image point of 70% of the maximum image height, the middle part shows the lateral aberration at the axial image point, and the lower part shows the lateral aberration at an image point of −70% of the maximum image height. In each lateral aberration diagram, the horizontal axis indicates the distance from the principal ray on the pupil surface, and the solid line, the short dash line and the long dash line indicate the characteristics to the d-line, the F-line and the C-line, respectively. In each lateral aberration diagram, the meridional plane is adopted as the plane containing the optical axis of the first lens unit G1 and the optical axis of the third lens unit G3.

Here, in the zoom lens system according to each numerical example, the amount of movement of the image blur compensating lens unit in a direction perpendicular to the optical axis in an image blur compensation state at a telephoto limit is as follows.

| | |
|---|---|
| Numerical Example 1 | 0.530 mm |
| Numerical Example 2 | 0.420 mm |
| Numerical Example 3 | 0.420 mm |
| Numerical Example 4 | 0.430 mm |
| Numerical Example 5 | 0.370 mm |

Here, when the shooting distance is infinity, at a telephoto limit, the amount of image decentering in a case that the zoom lens system inclines by 0.3° is equal to the amount of image decentering in a case that the image blur compensating lens unit displaces in parallel by each of the above-mentioned values in a direction perpendicular to the optical axis.

As seen from the lateral aberration diagrams, satisfactory symmetry is obtained in the lateral aberration at the axial image point. Further, when the lateral aberration at the +70% image point and the lateral aberration at the −70% image point are compared with each other in the basic state, all have a small degree of curvature and almost the same inclination in the aberration curve. Thus, decentering coma aberration and decentering astigmatism are small. This indicates that sufficient imaging performance is obtained even in the image blur compensation state. Further, when the image blur compensation angle of a zoom lens system is the same, the amount of parallel translation required for image blur compensation decreases with decreasing focal length of the entire zoom lens system. Thus, at arbitrary zoom positions, sufficient image blur compensation can be performed for image blur compensation angles up to 0.3° without degrading the imaging characteristics.

### Numerical Example 1

The zoom lens system of Numerical Example 1 corresponds to Embodiment 1 shown in FIG. 1. Table 1 shows the surface data of the zoom lens system of Numerical Example 1. Table 2 shows the aspherical data. Table 3 shows the various data.

TABLE 1
(Surface data)

| Surface number | r | d | nd | vd |
|---|---|---|---|---|
| Object surface | ∞ | | | |
| 1 | 61.27940 | 1.00000 | 1.75789 | 32.1 |
| 2 | 40.69340 | 8.40730 | 1.48749 | 70.4 |
| 3 | −306.72730 | Variable | | |
| 4 | 285.57580 | 0.80000 | 1.71281 | 51.6 |
| 5 | 26.41460 | 0.15000 | | |
| 6 | 19.33410 | 4.57660 | 1.66359 | 27.1 |
| 7 | −314.64810 | 8.30350 | | |
| 8 | −28.72870 | 0.80000 | 1.84109 | 35.0 |
| 9 | 40.67860 | Variable | | |
| 10(Diaphragm) | ∞ | 1.00000 | | |
| 11 | 34.45080 | 8.00000 | 1.54360 | 56.0 |
| 12* | −50.22320 | 1.00000 | | |
| 13 | 16.40790 | 5.63390 | 1.51527 | 63.9 |
| 14 | 183.34550 | 0.80000 | 1.92286 | 20.9 |
| 15 | 17.26960 | Variable | | |
| 16 | 50.05180 | 6.66420 | 1.88895 | 29.8 |
| 17 | −64.42020 | Variable | | |
| 18 | −34.81100 | 0.80000 | 1.70164 | 52.4 |
| 19 | −538.19780 | (BF) | | |
| Image surface | ∞ | | | |

TABLE 2
(Aspherical data)

Surface No. 12
K = 0.00000E+00, A4 = 1.17607E−05, A6 = −1.86330E−07,
A8 = 8.69894E−09 A10 = −1.31222E−10

TABLE 3
(Various data)
Zooming ratio 3.13564

| | Wide-angle | Middle | Telephoto |
|---|---|---|---|
| | limit | position | limit |
| Focal length | 46.2703 | 81.9323 | 145.0869 |
| F-number | 5.65283 | 5.68565 | 5.80316 |
| View angle | 13.6611 | 7.5404 | 4.2062 |
| Image height | 10.8150 | 10.8150 | 10.8150 |
| Overall length | 127.8176 | 148.4343 | 165.1036 |
| of lens system | | | |
| BF | 20.69678 | 20.68850 | 22.54673 |
| d3 | 1.0372 | 33.2632 | 59.2618 |
| d9 | 23.0284 | 11.3434 | 2.0000 |
| d15 | 20.1096 | 18.6476 | 22.5409 |
| d17 | 15.0101 | 16.5561 | 10.8187 |
| Entrance pupil | 50.3562 | 116.6691 | 197.7937 |
| position | | | |
| Exit pupil | −47.1011 | −44.0573 | −52.9477 |
| position | | | |
| Front principal | 65.0482 | 94.9205 | 64.0491 |
| points position | | | |
| Back principal | 81.5473 | 66.5020 | 20.0167 |
| points position | | | |

Zoom lens unit data

| | Initial | | Overall | | |
|---|---|---|---|---|---|
| Lens | surface | Focal | length of | Front principal | Back principal |
| unit | No. | length | lens unit | points position | points position |
| 1 | 1 | 137.06118 | 9.40730 | 0.84168 | 3.97338 |
| 2 | 4 | −31.40024 | 14.63010 | 17.94876 | 18.35565 |
| 3 | 10 | 51.28386 | 16.43390 | −10.52101 | −0.50657 |
| 4 | 16 | 32.57836 | 6.66420 | 1.58603 | 4.62286 |
| 5 | 18 | −53.07959 | 0.80000 | −0.03253 | 0.29702 |

### Numerical Example 2

The zoom lens system of Numerical Example 2 corresponds to Embodiment 2 shown in FIG. 4. Table 4 shows the surface data of the zoom lens system of Numerical Example 2. Table 5 shows the aspherical data. Table 6 shows the various data.

TABLE 4
(Surface data)

| Surface number | r | d | nd | vd |
|---|---|---|---|---|
| Object surface | ∞ | | | |
| 1 | 50.10770 | 1.00000 | 1.74950 | 35.0 |
| 2 | 35.56720 | 3.56920 | 1.48749 | 70.4 |
| 3 | −6005.16460 | Variable | | |
| 4 | 173.07500 | 0.80000 | 1.72000 | 50.3 |
| 5 | 22.00370 | 0.15000 | | |
| 6 | 17.26830 | 3.50780 | 1.64769 | 33.8 |
| 7 | −140.71570 | 7.29020 | | |
| 8 | −25.44790 | 0.80000 | 1.83481 | 42.7 |
| 9 | 39.10450 | Variable | | |
| 10(Diaphragm) | ∞ | 1.00000 | | |
| 11 | 34.32450 | 2.34930 | 1.54360 | 56.0 |
| 12* | −42.96930 | 1.00000 | | |
| 13 | 15.47070 | 6.17580 | 1.51823 | 59.0 |
| 14 | 76.35180 | 0.80000 | 1.92286 | 20.9 |
| 15 | 15.36060 | Variable | | |
| 16 | 51.49770 | 2.73170 | 1.90366 | 31.3 |
| 17 | −58.98800 | Variable | | |
| 18 | −37.45950 | 0.80000 | 1.80420 | 46.5 |
| 19 | 506.98340 | (BF) | | |
| Image surface | ∞ | | | |

TABLE 5
(Aspherical data)
Surface No. 12

K = 0.00000E+00, A4 = 1.18077E−05, A6 = 9.50364E−09,
A8 = 1.27831E−09 A10 = −1.91534E−11

TABLE 6
(Various data)
Zooming ratio 3.13580

| | Wide-angle | Middle | Telephoto |
|---|---|---|---|
| | limit | position | limit |
| Focal length | 46.2829 | 81.9616 | 145.1341 |
| F-number | 4.68072 | 5.50123 | 5.80439 |
| View angle | 13.4707 | 7.5350 | 4.2469 |
| Image height | 10.8150 | 10.8150 | 10.8150 |
| Overall length | 98.7028 | 120.2583 | 148.5392 |
| of lens system | | | |
| BF | 16.42161 | 25.14177 | 31.16653 |
| d3 | 1.0000 | 22.6402 | 51.0000 |
| d9 | 16.9101 | 8.1041 | 2.0000 |
| d15 | 14.3639 | 15.4828 | 21.6576 |
| d17 | 18.0332 | 16.9154 | 10.7411 |
| Entrance pupil | 37.0527 | 69.9993 | 145.3536 |
| position | | | |
| Exit pupil | −45.2326 | −55.2210 | −70.0652 |
| position | | | |
| Front principal | 36.1385 | 30.4620 | −10.1867 |
| points position | | | |
| Back principal | 52.4199 | 38.2967 | 3.4051 |
| points position | | | |

Zoom lens unit data

| | Initial | | Overall | | |
|---|---|---|---|---|---|
| Lens | surface | Focal | length of | Front principal | Back principal |
| unit | No. | length | lens unit | points position | points position |
| 1 | 1 | 129.31381 | 4.56920 | −0.51321 | 1.08863 |
| 2 | 4 | −29.09088 | 12.54800 | 15.30553 | 15.73719 |
| 3 | 10 | 43.55664 | 11.32510 | −10.12765 | −2.72406 |
| 4 | 16 | 30.78708 | 2.73170 | 0.67679 | 1.95647 |
| 5 | 18 | −43.34661 | 0.80000 | 0.03049 | 0.38737 |

### Numerical Example 3

The zoom lens system of Numerical Example 3 corresponds to Embodiment 3 shown in FIG. 7. Table 7 shows the surface data of the zoom lens system of Numerical Example 3. Table 8 shows the aspherical data. Table 9 shows the various data.

TABLE 7
(Surface data)

| Surface number | r | d | nd | vd |
|---|---|---|---|---|
| Object surface | ∞ | | | |
| 1 | 52.71520 | 1.00000 | 1.74950 | 35.0 |
| 2 | 37.32200 | 3.85030 | 1.48749 | 70.4 |
| 3 | −5452.64230 | Variable | | |
| 4 | 167.78640 | 0.80000 | 1.72000 | 50.3 |
| 5 | 23.56360 | 0.15000 | | |
| 6 | 17.86810 | 4.29100 | 1.64769 | 33.8 |
| 7 | −187.93060 | 8.04330 | | |
| 8 | −24.79330 | 0.80000 | 1.83481 | 42.7 |
| 9 | 40.64550 | Variable | | |
| 10(Diaphragm) | ∞ | 1.00000 | | |
| 11 | 34.77280 | 4.33200 | 1.54360 | 56.0 |
| 12* | −43.92450 | 1.00000 | | |
| 13 | 16.16060 | 5.24700 | 1.51823 | 59.0 |
| 14 | 82.99030 | 0.80000 | 1.92286 | 20.9 |
| 15 | 16.57710 | Variable | | |
| 16 | 52.00520 | 9.72630 | 1.90366 | 31.3 |
| 17 | −59.44140 | Variable | | |
| 18 | −36.34900 | 0.80000 | 1.80420 | 46.5 |
| 19 | 897.21280 | (BF) | | |
| Image surface | ∞ | | | |

TABLE 8
(Aspherical data)
Surface No. 12

K = 0.00000E+00, A4 = 1.20203E−05, A6 = −5.69152E−08,
A8 = 2.76958E−09 A10 = −3.13041E−11

TABLE 9
(Various data)
Zooming ratio 3.13571

| | Wide-angle | Middle | Telephoto |
|---|---|---|---|
| | limit | position | limit |
| Focal length | 46.2784 | 81.9509 | 145.1159 |
| F-number | 4.60415 | 5.47001 | 5.80468 |
| View angle | 13.5010 | 7.5421 | 4.2503 |
| Image height | 10.8150 | 10.8150 | 10.8150 |
| Overall length | 92.2530 | 103.5680 | 126.7700 |
| of lens system | | | |
| BF | 15.7837 | 25.1939 | 31.5158 |
| d3 | 1.0000 | 21.7256 | 51.2498 |
| d9 | 17.7350 | 8.3229 | 2.0000 |
| d15 | 14.0268 | 14.9164 | 20.4554 |
| d17 | 17.6510 | 16.7633 | 11.2252 |
| Entrance pupil | 41.0099 | 71.2600 | 146.5295 |
| position | | | |
| Exit pupil | −46.7467 | −57.1125 | −70.9821 |
| position | | | |
| Front principal | 41.5582 | 35.7032 | −5.2081 |
| points position | | | |
| Back principal | 61.8446 | 46.8519 | 13.1276 |
| points position | | | |

Zoom lens unit data

| | Initial | | Overall | | |
|---|---|---|---|---|---|
| Lens | surface | Focal | length of | Front principal | Back principal |
| unit | No. | length | lens unit | points position | points position |
| 1 | 1 | 136.20835 | 4.85030 | −0.50796 | 1.18557 |
| 2 | 4 | −29.69711 | 14.08430 | 17.64231 | 17.82483 |
| 3 | 10 | 46.44281 | 12.37900 | −8.42427 | −1.29740 |
| 4 | 16 | 32.02139 | 9.72630 | 2.48722 | 6.88343 |
| 5 | 18 | −43.42253 | 0.80000 | 0.01726 | 0.37402 |

### Numerical Example 4

The zoom lens system of Numerical Example 4 corresponds to Embodiment 4 shown in FIG. 10. Table 10 shows the surface data of the zoom lens system of Numerical Example 4. Table 11 shows the aspherical data. Table 12 shows the various data.

TABLE 10
(Surface data)

| Surface number | r | d | nd | vd |
|---|---|---|---|---|
| Object surface | ∞ | | | |
| 1 | 47.51780 | 4.95330 | 1.48749 | 70.4 |
| 2 | −105.85580 | 1.00000 | 1.74950 | 35.0 |
| 3 | −537.17660 | Variable | | |
| 4 | −55.44130 | 0.80000 | 1.83481 | 42.7 |
| 5 | 52.20110 | 0.15000 | | |
| 6 | 23.20160 | 2.29870 | 1.84666 | 23.8 |
| 7 | −55.02810 | 1.71620 | | |
| 8 | −42.03460 | 0.80000 | 1.90366 | 31.3 |
| 9 | 25.39230 | Variable | | |
| 10(Diaphragm) | ∞ | 1.00000 | | |
| 11 | 31.98410 | 2.61120 | 1.54360 | 56.0 |
| 12* | −48.34570 | 1.00000 | | |
| 13 | 23.84160 | 2.32120 | 1.48749 | 70.4 |
| 14 | −83.26550 | 0.80000 | 1.92286 | 20.9 |
| 15 | 63.42040 | Variable | | |
| 16 | 30.41840 | 0.50000 | 1.92286 | 20.9 |
| 17 | 19.72920 | Variable | | |
| 18 | 39.19300 | 2.97820 | 1.90366 | 31.3 |
| 19 | −54.00310 | Variable | | |
| 20 | −41.37490 | 0.80000 | 1.48749 | 70.4 |
| 21 | 21.76680 | (BF) | | |
| Image surface | ∞ | | | |

TABLE 11
(Aspherical data)
Surface No. 12

K = 0.00000E+00, A4 = 1.08514E−05, A6 = −1.50203E−08,
A8 = 5.03917E−10 A10 = −4.55682E−12

TABLE 12
(Various data)
Zooming ratio 3.13596

| | Wide-angle | Middle | Telephoto |
|---|---|---|---|
| | limit | position | limit |
| Focal length | 46.2695 | 81.9328 | 145.0994 |
| F-number | 4.16144 | 4.65570 | 5.80338 |
| View angle | 13.3167 | 7.5087 | 4.1880 |
| Image height | 10.8150 | 10.8150 | 10.8150 |
| Overall length | 69.6241 | 84.0368 | 103.6938 |
| of lens system | | | |
| BF | 22.0089 | 32.4982 | 32.8545 |
| d3 | 6.4615 | 31.4306 | 51.4616 |
| d9 | 15.8624 | 9.4107 | 2.0000 |
| d15 | 6.1455 | 0.6000 | 6.9691 |
| d17 | 5.3816 | 9.3740 | 14.5348 |
| d19 | 11.9599 | 9.4755 | 5.0000 |
| Entrance pupil | 33.1193 | 83.1992 | 142.4779 |
| position | | | |
| Exit pupil | −41.2642 | −51.2909 | −62.2687 |
| position | | | |
| Front principal | 27.6129 | 34.2951 | −50.5381 |
| points position | | | |
| Back principal | 45.3635 | 34.6021 | −8.5511 |
| points position | | | |

Zoom lens unit data

| | Initial | | Overall | | |
|---|---|---|---|---|---|
| Lens | surface | Focal | length of | Front principal | Back principal |
| unit | No. | length | lens unit | points position | points position |
| 1 | 1 | 108.57993 | 5.95330 | −0.30315 | 1.75559 |
| 2 | 4 | −29.37657 | 5.76490 | 5.00701 | 6.71836 |
| 3 | 10 | 33.04577 | 7.73240 | 0.55295 | 2.83906 |
| 4 | 16 | −62.23372 | 0.50000 | 0.75696 | 0.99096 |
| 5 | 18 | 25.51901 | 2.97820 | 0.66806 | 2.05770 |
| 6 | 20 | −29.13737 | 0.80000 | 0.35096 | 0.61536 |

### Numerical Example 5

The zoom lens system of Numerical Example 5 corresponds to Embodiment 5 shown in FIG. 13. Table 13 shows the surface data of the zoom lens system of Numerical Example 5. Table 14 shows the aspherical data. Table 15 shows the various data.

TABLE 13
(Surface data)

| Surface number | r | d | nd | vd |
|---|---|---|---|---|
| Object surface | ∞ | | | |
| 1 | 54.95600 | 1.00000 | 1.71736 | 29.5 |
| 2 | 38.53860 | 3.69520 | 1.48749 | 70.4 |
| 3 | −1004.07190 | Variable | | |
| 4 | 201.06910 | 0.80000 | 1.69680 | 55.5 |
| 5 | 21.89400 | 0.15000 | | |
| 6 | 17.67150 | 3.32400 | 1.67270 | 32.2 |
| 7 | 2396.10290 | 9.66230 | | |
| 8 | −25.22900 | 0.80000 | 1.83481 | 42.7 |
| 9 | 44.02730 | Variable | | |
| 10(Diaphragm) | ∞ | 1.00000 | | |
| 11 | 28.04510 | 2.58250 | 1.51845 | 70.0 |
| 12* | −37.26800 | 1.00000 | | |
| 13 | 14.41890 | 4.85360 | 1.51680 | 64.2 |
| 14 | 65.78910 | 0.80000 | 1.84666 | 23.8 |
| 15 | 14.01740 | Variable | | |
| 16 | 50.72160 | 2.59670 | 1.90366 | 31.3 |
| 17 | −63.39020 | Variable | | |
| 18 | −40.42620 | 0.80000 | 1.80420 | 46.5 |
| 19 | 155.08050 | (BF) | | |
| Image surface | ∞ | | | |

TABLE 14
(Aspherical data)
Surface No. 12

K = 0.00000E+00, A4 = 1.60994E−05, A6 = 2.40007E−07,
A8 = −6.26914E−09 A10 = 6.71437E−11

TABLE 15
(Various data)
Zooming ratio 3.13598

| | Wide-angle | Middle | Telephoto |
|---|---|---|---|
| | limit | position | limit |
| Focal length | 46.2885 | 81.9728 | 145.1597 |
| F-number | 4.64482 | 5.43438 | 5.80626 |
| View angle | 13.5435 | 7.5330 | 4.2330 |
| Image height | 10.8150 | 10.8150 | 10.8150 |
| Overall length | 81.7329 | 95.7774 | 118.4980 |
| of lens system | | | |
| BF | 17.1082 | 25.0682 | 30.2648 |
| d3 | 1.0000 | 23.1158 | 51.0000 |
| d9 | 15.1939 | 7.1788 | 2.0000 |
| d15 | 16.8807 | 17.2024 | 22.2798 |
| d17 | 15.4478 | 15.1256 | 10.0469 |
| Entrance pupil | 38.8175 | 74.1738 | 153.3546 |
| position | | | |
| Exit pupil | −45.9533 | −54.2981 | −65.6927 |
| position | | | |
| Front principal | 38.6278 | 32.5998 | −21.7206 |
| points position | | | |
| Back principal | 52.4065 | 38.7823 | 3.4960 |
| points position | | | |

Zoom lens unit data

| | Initial | | Overall | | |
|---|---|---|---|---|---|
| Lens | surface | Focal | length of | Front principal | Back principal |
| unit | No. | length | lens unit | points position | points position |
| 1 | 1 | 131.45397 | 4.69520 | −0.26030 | 1.36639 |
| 2 | 4 | −27.07782 | 14.73630 | 17.25990 | 17.46816 |
| 3 | 10 | 36.92989 | 10.23610 | −6.64500 | −0.95574 |
| 4 | 16 | 31.52079 | 2.59670 | 0.61293 | 1.83068 |
| 5 | 18 | −39.80184 | 0.80000 | 0.09152 | 0.44892 |

The following Table 16 shows the corresponding values to the individual conditions in the zoom lens systems of each of Numerical Examples.

TABLE 16
(Values corresponding to conditions)

| | Numerical Example | | | | |
|---|---|---|---|---|---|
| Condition | 1 | 2 | 3 | 4 | 5 |
| (1) L_{T}/f_{T} | 1.14 | 1.02 | 1.09 | 0.94 | 1.02 |
| (2) T_{3subG}/T_{1G} | 0.85 | 0.51 | 0.89 | 0.44 | 0.55 |
| (3) T_{1G}/f_{W} | 0.20 | 0.10 | 0.10 | 0.13 | 0.10 |
| (4) T_{4G}/T_{3G} | 0.43 | 0.26 | 0.85 | 0.07 | 0.28 |
| (5) f_{3G}/f_{2G} | −1.63 | −1.50 | −1.56 | −1.12 | −1.36 |

The present disclosure is applicable to a digital still camera, a digital video camera, a camera for a mobile terminal device such as a smart-phone, a camera for a PDA (Personal Digital Assistance), a surveillance camera in a surveillance system, a Web camera, a vehicle-mounted camera or the like. In particular, the present disclosure is applicable to a photographing optical system where high image quality is required like in a digital still camera system or a digital video camera system.

Also, the present disclosure is applicable to, among the interchangeable lens apparatuses in the present disclosure, an interchangeable lens apparatus having motorized zoom function, i.e., activating function for the zoom lens system by a motor, with which a digital video camera system is provided.

As described above, embodiments have been described as examples of art in the present disclosure. Thus, the attached drawings and detailed description have been provided.

Therefore, in order to illustrate the art, not only essential elements for solving the problems but also elements that are not necessary for solving the problems may be included in elements appearing in the attached drawings or in the detailed description. Therefore, such unnecessary elements should not be immediately determined as necessary elements because of their presence in the attached drawings or in the detailed description.

Further, since the embodiments described above are merely examples of the art in the present disclosure, it is understood that various modifications, replacements, additions, omissions, and the like can be performed in the scope of the claims or in an equivalent scope thereof.

What is claimed is:

1. A zoom lens system having a plurality of lens units, each lens unit being composed of at least one lens element, the zoom lens system, in order from an object side to an image side, comprising:
a first lens unit having positive optical power;
a second lens unit having negative optical power; and
a third lens unit having positive optical power, wherein
the zoom lens system is provided with an image blur compensating lens unit which moves in a direction perpendicular to an optical axis in order to optically compensate image blur, which is a part of the third lens unit, and which is positioned closest to the object side in the third lens unit, and wherein
the following condition (1) is satisfied:
0.5<L_{T}/f_{T}<1.2 (1)
where,
L_{T} is an overall length of lens system at a telephoto limit (a distance from an object side surface of a lens element arranged closest to the object side in the first lens unit, to an image surface at a telephoto limit), and
f_{T} is a focal length of the entire system at a telephoto limit.

2. The zoom lens system as claimed in claim 1, wherein the following condition (2) is satisfied:
0.3<T_{3subG}/T_{1G}<1.5 (2)
where,
T_{3subG} is an optical axial thickness of the image blur compensating lens unit, and
T_{IG} is an optical axial thickness of the first lens unit.

3. The zoom lens system as claimed in claim 1, wherein the following condition (3) is satisfied:
0.05<T_{1G}/f_{w}<0.3 (3)
where,
T_{1G} is an optical axial thickness of the first lens unit, and
f_{w} is a focal length of the entire system at a wide-angle limit.

4. The zoom lens system as claimed in claim 1, further including:
a fourth lens unit arranged on the image side relative to the third lens unit, wherein
the following condition (4) is satisfied:
0.03<T_{4G}/T_{3G}<0.9 (4)
where,
T_{3G} is an optical axial thickness of the third lens unit, and
T_{4G} is an optical axial thickness of the fourth lens unit.

5. The zoom lens system as claimed in claim 1, wherein the following condition (5) is satisfied:
−2.0<f_{3G}/f_{2G}<−1.0 (5)
where,
f_{2G} is a focal length of the second lens unit, and
f_{3G} is a focal length of the third lens unit.

6. The zoom lens system as claimed in claim 1, wherein the image blur compensating lens unit is composed of one lens element.

7. The zoom lens system as claimed in claim 1, wherein the first lens unit is composed of two or less lens elements.

8. The zoom lens system as claimed in claim 1, wherein at least one lens unit is fixed relative to the image surface, in zooming from a wide-angle limit to a telephoto limit at the time of image taking

9. An interchangeable lens apparatus comprising:
a zoom lens system as claimed in claim 1; and
a lens mount section which is connectable to a camera body including an image sensor for receiving an optical image formed by the zoom lens system and converting the optical image into an electric image signal.

10. A camera system comprising:
an interchangeable lens apparatus including a zoom lens system as claimed in claim 1; and
a camera body which is detachably connected to the interchangeable lens apparatus via a camera mount section, and includes an image sensor for receiving an optical image formed by the zoom lens system and converting the optical image into an electric image signal.

11. A zoom lens system having a plurality of lens units, each lens unit being composed of at least one lens element, the zoom lens system, in order from an object side to an image side, comprising:
a first lens unit having positive optical power;
a second lens unit having negative optical power;
a third lens unit having positive optical power;
a fourth lens unit having positive optical power; and
a fifth lens unit having negative optical power, wherein
in zooming from a wide-angle limit to a telephoto limit at the time of image taking, the first lens unit and the fifth lens unit individually move relative to an image surface, wherein
in focusing from an infinity in-focus condition to a close-object in-focus condition, the fourth lens unit moves relative to the image surface, and wherein
the following condition (4) is satisfied:
0.03<T_{4G}/T_{3G}<0.9 (4)
where,
T_{3G} is an optical axial thickness of the third lens unit, and
T_{4G} is an optical axial thickness of the fourth lens unit.

12. The zoom lens system as claimed in claim 11, further including:
an image blur compensating lens unit which moves in a direction perpendicular to an optical axis in order to optically compensate image blur, which is a part of the third lens unit, and which is positioned closest to the object side in the third lens unit, wherein
the following condition (2) is satisfied:
0.3<T_{3subG}/T_{1G}<1.5 (2)
where,
T_{3subG} is an optical axial thickness of the image blur compensating lens unit, and
T_{1G} is an optical axial thickness of the first lens unit.

13. The zoom lens system as claimed in claim 11, wherein the following condition (3) is satisfied:
0.05<T_{1G}/f_{W}<0.3 (3)
where,
T_{1G} is an optical axial thickness of the first lens unit, and
f_{W} is a focal length of the entire system at a wide-angle limit.

14. The zoom lens system as claimed in claim 11, wherein the following condition (5) is satisfied:
−2.0<f_{3G}/f_{2G}<−1.0 (5)
where,
f_{2G} is a focal length of the second lens unit, and
f_{3G} is a focal length of the third lens unit.

15. The zoom lens system as claimed in claim 11, wherein the fourth lens unit is composed of one lens element.

16. The zoom lens system as claimed in claim 11, wherein the first lens unit is composed of two or less lens elements.

17. The zoom lens system as claimed in claim 11, wherein at least one lens unit is fixed relative to the image surface, in zooming from a wide-angle limit to a telephoto limit at the time of image taking

18. An interchangeable lens apparatus comprising:
a zoom lens system as claimed in claim 11; and
a lens mount section which is connectable to a camera body including an image sensor for receiving an optical image formed by the zoom lens system and converting the optical image into an electric image signal.

19. A camera system comprising:
an interchangeable lens apparatus including a zoom lens system as claimed in claim 11; and
a camera body which is detachably connected to the interchangeable lens apparatus via a camera mount section, and includes an image sensor for receiving an optical image formed by the zoom lens system and converting the optical image into an electric image signal.
